(19) United States
(12) Patent Application Publication
(10) Pub. No.: US 2026/0179578 A1
(43) Pub. Date: Jun. 25, 2026

(54) CLOCK TIMING METHOD AND DEVICE BASED ON THE FIBONACCI SEQUENCE

(71) Applicant: SHENZHEN XINGTONG TECHNOLOGY CO, LTD., Shenzhen, Guangdong (CN)

(72) Inventors: Zhengyuan CHEN, Shenzhen, Guangdong (CN); Gang XIONG, Shenzhen, Guangdong (CN); Tianqi XIONG, Shenzhen, Guangdong (CN)

(21) Appl. No.: 18/853,057

(22) PCT Filed: Apr. 7, 2024
(86) PCT No.: PCT/CN2024/086297

§ 371 Date: Sep. 30, 2024

(30) Foreign Application Priority Data
Sep. 15, 2023 (CN) 2023111947292

(51) Int. Cl. G09G 3/34

(52) U.S. Cl. CPC G09G 3/3413

(57) ABSTRACT

A clock timing method and device based on the Fibonacci sequence, using the first six digits of the Fibonacci sequence as the basis to form a combination of six square color blocks, wherein a first color block area corresponds to side length 1, a second color block area corresponds to side length 1, a third color block area corresponds to side length 2, a fourth color block area corresponds to side length 3, a fifth color block area corresponds to side length 5, and a sixth color block area corresponds to side length 8. The invention adopts first six digits of Fibonacci sequence (1, 1, 2, 3, 5, 8) corresponding to six color blocks in the interface, and each color block can display six colors of red, green, blue, yellow, purple, and white, accurately corresponding to time scale from 0:00 to 12:59, minimum precision of scale being 1 minute.

### TECHNICAL FIELD

The invention relates to the technical field of clock products, in particular to a clock timing method and device based on the Fibonacci sequence.

### BACKGROUND ART

In people's daily life, clocks play a vital role as a tool for measuring time. Traditional clocks have two main forms: mechanical and electronic display. Mechanical clocks scale time through the hour, minute and second hands, while electronic screens or digital tubes use electronic displays. Although these designs provide users with an intuitive time scale, they are monotonous in terms of the product's interest and user experience.

The Fibonacci sequence, also known as the golden section sequence, was introduced by mathematician Leonardo Fibonacci as an example of rabbit reproduction, and is therefore also known as the “rabbit sequence”, which is characterized by the fact that each number is the sum of the first two numbers, specifically: 1, 1, 2, 3, 5, 8, 13, 21, 34, and so on . . . , etc. The recurrence method for this sequence is defined as F(0)=1, F(1)=1, F(n)=F(n−1)+F(n−2) (wherein n≥2 and nϵN*).

Clock designs based on the Fibonacci sequence have appeared on the market, the most well-known design is probably the Fibonacci clock released by Philippe Chrétien in 2015 on the maker platform, which uses five color blocks (corresponding to 1, 1, 2, 3, and 5 in the sequence) and four colors (red, green, blue, and white) to represent the time. It defines the number of hours=red+blue; the number of minutes=(green+blue)*5. However, this design approach only displays time scales where minutes are multiples of 5, such as 1:05, 1:10, etc., and is unable to display the exact time between 1:05 and 1:10, e.g., the minute of 1:08 can not be displayed in this clock, so there is a problem of accuracy.

In addition to Chrétien's design, there are some other clock products based on the Fibonacci sequence. However, these designs are either too simple, as in the case of Philippe Chrétien's product, which can only realize 5 minutes as the smallest unit of time, or too complex, as the clock device of Cnedutech (Jiangsu) Technology Co., Ltd., which provides a cumbersome product interface for the consumers, and whose method of timekeeping with the remainder of the minutes deviates from the original mathematical expression of the Fibonacci sequence.

Although the Fibonacci sequence provides a novel perspective on clock design, the design solutions still have some shortcomings in terms of accuracy, interface design, and user experience.

### SUMMARY OF THE INVENTION

In order to solve said technical problem, the invention provides a clock timing method and device based on the Fibonacci sequence, the timing algorithm of which uses the first six digits of the Fibonacci sequence (1, 1, 2, 3, 5, 8) and uses these six digits in order as the side lengths of the corresponding squares to form a combination of six square color blocks, which can realize corresponding display of time, in line with people's expression habit of time; at the same time, the algorithm is simple and efficient, which requires only 6 color blocks to achieve the display of time with 6 colors; the product has a strong presentation, novel and interesting, and possesses practicability of the clock, being an effective solution to the many deficiencies in prior art.

The invention is realized by the following technical solution: a clock timing method and device based on the Fibonacci sequence, which uses the first six digits of the Fibonacci sequence as the basis to form a combination of six square color blocks, wherein a first color block area corresponds to side length 1, a second color block area corresponds to side length 1, a third color block area corresponds to side length 2, a fourth color block area corresponds to side length 3, a fifth color block area corresponds to side length 5, and a sixth color block area corresponds to side length 8.

The steps are as follows:
a) provide six square color blocks, each of which corresponds to a number in the Fibonacci sequence, 1, 1, 2, 3, 5, 8;
b) based on the current number of hours, the sum of the side length values of the corresponding red and blue color block combinations are selected to represent current number of hours;
c) according to the current number of minutes, it is represented by calculating side length values of corresponding green and blue color blocks in combination, and finely tuned by the side length values of yellow and purple color blocks;
d) using seven-color LED light arrays to display the corresponding time according to the color and position of the selected color block.

As a preferred technical solution, backs of said six color block areas are equipped with seven-color LED light arrays, which can make the color blocks display six colors of red, green, blue, yellow, purple and white respectively.

As a preferred technical solution, the number of hours of the clock is determined by the sum of the side length values of the red and blue color block areas; the number of minutes is determined by multiplying the sum of the side length values of the green and blue color block areas by 5 plus the side length value of the yellow color block area and subtracting the side length value of the purple color block area.

As a preferred technical solution, the white color block area is not involved in the calculation of the number of hours and minutes.

As a preferred technical solution, the device is provided with a night light mode, capable of providing illumination in dim light conditions.

As a preferred technical solution, a control unit is provided for adjusting the display color of each color block area according to the value of the time to realize display of time.

As a preferred technical solution, a sound feedback function is provided, which emits a specific sound effect to notify the user when the time is changed or a setting is made.

A program of the clock timing method based on the Fibonacci sequence of the invention is used to control the LED light array so that the color block area displays a corresponding combination of colors to indicate a specific time points, and the program is capable of corresponding to 780 time points in minutes within a time range of 0:00 to 12:59.

The invention provides a clock timing device based on the Fibonacci sequence, including a physical frame, and six square color block areas are provided in a space area formed in a middle of the physical frame, and the six square color block areas include a first color block area, a second color block area, a third color block area, a fourth color block area, a fifth color block area, and a sixth color block area;
wherein, a first color block area corresponds to side length 1, a second color block area corresponds to side length 1, a third color block area corresponds to side length 2, a fourth color block area corresponds to side length 3, a fifth color block area corresponds to side length 5, and a sixth color block area corresponds to side length 8; the back of each color block area is equipped with a seven-color LED light array, which can make the color block display six colors of red, green, blue, yellow, purple and white respectively.

The advantageous effects of the invention are as follows: the timing algorithm of the invention adopts the design of the first six digits of the Fibonacci sequence (1, 1, 2, 3, 5, 8), which is capable of realizing the accurate display in minutes within the time range of 0:00 to 12:59, and meets the needs of daily timing;

The invention combines the mathematical Fibonacci sequence and the design of color changes, which not only satisfies the consumers' habitual expression of time, but also brings the sensory experience of the product's multiple display color changes of the time points, and stimulates the thinking of mathematics and time.

The complete representation of time is achieved through the design of only 6 color blocks, compared with other Fibonacci clock products on the market, this algorithm is both simple and efficient, and can achieve a better balance; compared with traditional clocks and other Fibonacci clocks, the invention has a higher degree of innovativeness, and realizes the display of time in a novel way to satisfy consumers' requirements for products in terms of interesting and practicality.

The present invention not only provides a novel and chic clock product, but also may bring good social and economic returns. The seven-color LED light arrays are used, which can flexibly change the color according to the need, adds extra attraction and adjustability to the product, avoids overly complex or simple interface design, and brings intuitive and clear time display to the user.

### BRIEF DESCRIPTION OF ACCOMPANY DRAWINGS

In order to more clearly illustrate the technical solutions in the embodiments or prior art of the invention, the accompanying drawings to be used in the description of the embodiments or prior art will be briefly introduced below, and it will be obvious that the accompanying drawings in the following description are only some embodiments of the invention, and that for the person of ordinary skill in the art, other attachments can be obtained on the basis of the accompanying drawings without creative labor.

FIG. 1 is a structural diagram of the invention.

FIG. 2 is an effect picture of the product provided by the invention.

### SPECIFIC EMBODIMENT OF THE INVENTION

All of the features disclosed in this specification, or all of the steps in the disclosed method or process, may be combined in any manner except for mutually exclusive features and/or steps.

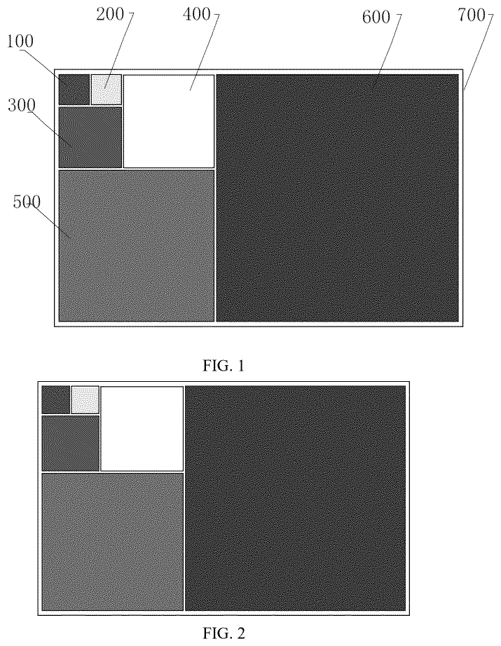

As shown in FIG. 1, the invention provides a clock timing method and device based on the Fibonacci sequence, which uses special color blocks to represent time.

In the embodiment, six square color block areas are provided in a space area formed in a middle of the physical frame 700, and the six square color block areas include a first color block area 100, a second color block area 200, a third color block area 300, a fourth color block area 400, a fifth color block area 500, and a sixth color block area 600;

Firstly, design of the block is based on the first six digits of the Fibonacci sequence and forms six square color block areas; specifically, the first color block area corresponds to side length 1, the second color block area corresponds to side length 1, the third color block area corresponds to side length 2, the fourth color block area corresponds to side length 3, the fifth color block area corresponds to side length 5, and the sixth color block area corresponds to side length 8;

In order to provide a richer visual experience, the back of each color block area is equipped with a seven-color LED light array, which can make the color block display one of red, green, blue, yellow, purple and white independently. Especially, the white color block area is not involved in the calculation of the number of hours and minutes, but in some modes, such as night light mode, it is capable of providing illumination.

The embodiment provides a clock timing method and device based on the Fibonacci sequence, which uses special color blocks to represent time.

Firstly, design of the block is based on the first six digits of the Fibonacci sequence and forms six square color block areas.

Specifically, the first color block area corresponds to side length 1, the second color block area corresponds to side length 1, the third color block area corresponds to side length 2, the fourth color block area corresponds to side length 3, the fifth color block area corresponds to side length 5, and the sixth color block area corresponds to side length 8.

In order to provide a richer visual experience, the back of each color block area is equipped with a seven-color LED light array, which can make the color block display one of red, green, blue, yellow, purple and white independently. Especially, the white color block area is not involved in the calculation of the number of hours and minutes, but in some modes, such as night light mode, it is capable of providing illumination.

In addition, the light array is able to adjust the brightness, which not only provides a clear display in well-lit environments, but also provides a comfortable visual experience in dimly lit environments.

Wherein, surfaces of the six square color blocks are made of translucent material, which enables the light emitted by the LED light array to pass through evenly, providing users with a soft visual effect, and the separating lines between the color blocks are detailed and clear, which helps the user to quickly identify each color block.

In the invention, the user can set the time, adjust the brightness and select the display mode via a touch screen or a physical button or a Bluetooth connection of a cell phone or tablet, equipped with an automatic brightness adjustment function that automatically adjusts the brightness of the LEDs according to the ambient brightness. When the user adjusts or sets the time, the control unit controls the color and state of each color block according to the current hours and minutes through a preset algorithmic logic.

The whole clock can be powered by USB, battery or direct power plug, providing users with a variety of choices and an energy-saving mode, which can be set to standby when users don't need to check the time, at which time the power consumption of the LED light array is extremely low.

### Embodiment 1

To represent time 3:28 as shown in FIG. 2:

Formula:

$$Number of hours = sum of ( red + blue ) color side length values . \qquad 1 )$$

$$Number of minutes = sum of ( green + blue ) color block side length values * 5 + yellow ( color block side length ) - purple ( color block side length ) . \qquad 2 )$$

So, it is shown as:
Color block 1 (side length 1): red
Color block 2 (side length 1): yellow
Color block 3 (side length 2): blue
Color block 4 (side length 3): white
Color block 5 (side length 5): green
Color block 6 (side length 8): purple.

Based on the above definition:

$$Number of hours = sum of ( red + blue ) color block side length value ,$$

$$i . e . the number of hours is : 1 + 2 = 3$$

$$Number of minutes = ( green + blue ) * 5 + yellow - purple = ( 5 + 2 ) * 5 + 1 - 8 = 28$$

So, the time derived from Embodiment 1 is: 3:28

### Embodiment 2

To represent time 4:21

Formula:

$$Number of hours = sum of ( red + blue ) color side length values . \qquad 1 )$$

$$Number of minutes = sum of ( green + blue ) color block side length values * 5 + yellow ( color block side length ) - purple ( color block side length ) . \qquad 2 )$$

So, it is shown as:
Color block 1 (side length 1): red
Color block 2 (side length 1): yellow
Color block 3 (side length 2): green
Color block 4 (side length 3): blue
Color block 5 (side length 5): purple
Color block 6 (side length 8): white.

Based on the above definition:

$$Number of hours = red + blue = 1 + 3 = 4$$

$$Number of minutes = ( green + blue ) * 5 + yellow - purple = ( 2 + 3 ) * 5 + 1 - 5 = 25 + 1 - 5 = 21$$

So, the time derived from Embodiment 2 is: 4:21.

### Embodiment 3

To represent time 6:33

Formula:

$$Number of hours = sum of ( red + blue ) color side length values . \qquad 1 )$$

$$Number of minutes = sum of ( green + blue ) color block side length values * 5 + yellow ( color block side length ) - purple ( color block side length ) . \qquad 2 )$$

So, it is shown as:
Color block 1 (side length 1): yellow
Color block 2 (side length 1): red
Color block 3 (side length 2): green
Color block 4 (side length 3): purple
Color block 5 (side length 5): blue
Color block 6 (side length 8): white.

Calculation is as follows:

$$Number of hours = red + blue = 1 + 5 = 6$$

$$Number of minutes = ( green + blue ) * 5 + yellow - purple = ( 2 + 5 ) * 5 + 1 - 3 = 35 + 1 - 3 = 33$$

So, the time derived from Embodiment 3 is: 6:33.

### Embodiment 4

To represent time 2:17

Formula:

$$Number of hours = sum of ( red + blue ) color side length values . \qquad 1 )$$

$$Number of minutes = sum of ( green + blue ) color block side length values * 5 + yellow ( color block side length ) - purple ( color block side length ) . \qquad 2 )$$

So, it is shown as:
Color block 1 (side length 1): yellow
Color block 2 (side length 1): yellow
Color block 3 (side length 2): red
Color block 4 (side length 3): green
Color block 5 (side length 5): white
Color block 6 (side length 8): white.

Calculation is as follows:

$$Number of hours = red + blue = 2 + 0 = 2$$

$$Number of minutes = ( green + blue ) * 5 + yellow - purple = ( 3 + 0 ) * 5 + 1 + 1 - 0 = 15 + 2 - 0 = 17$$

So, the time derived from Embodiment 4 is: 2:17.

In this way, the invention can combine the concept of time with the Fibonacci sequence to provide users with a novel and educational clock product.

The timing algorithm of the invention adopts the design of the first six digits of the Fibonacci sequence (1, 1, 2, 3, 5, 8), which is capable of realizing the accurate display in minutes within the time range of 0:00 to 12:59, and meets the needs of daily timing;

The invention combines the mathematical Fibonacci sequence and the design of color changes, which not only satisfies the consumers' habitual expression of time, but also brings the sensory experience of the product's multiple display color changes of the time points, and stimulates the thinking of mathematics and time.

The complete representation of time is achieved through the design of only 6 color blocks, compared with other Fibonacci clock products on the market, this algorithm is both simple and efficient, and can achieve a better balance; compared with traditional clocks and other Fibonacci clocks, the invention has a higher degree of innovativeness, and realizes the display of time in a novel way to satisfy consumers' requirements for products in terms of interesting and practicality.

The algorithm of the invention has a total of 6 display color blocks, color blocks can be presented in different color combinations through LED lights at the back, so the entire color display combinations include red, green, blue, yellow, purple, white color, a total of 66, i.e., 46,656 kinds of combinations, retaining useful combinations in the program can corresponds to 780 time points of any time from 0:00 to 12:59.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A clock timing method based on the Fibonacci sequence, which uses the first six digits of the Fibonacci sequence as the basis to form a combination of six square color blocks;
wherein a first color block area corresponds to side length 1, a second color block area corresponds to side length 1, a third color block area corresponds to side length 2, a fourth color block area corresponds to side length 3, a fifth color block area corresponds to side length 5, and a sixth color block area corresponds to side length 8;
the steps are as follows:
a) provide six square color blocks, each of which corresponds to a number in the Fibonacci sequence, 1, 1, 2, 3, 5, 8;
b) based on the current number of hours, the sum of the side length values of the corresponding red and blue color block combinations are selected to represent current number of hours;
c) according to the current number of minutes, it is represented by calculating side length values of corresponding green and blue color blocks in combination, and finely tuned by the side length values of yellow and purple color blocks;
d) using seven-color LED light arrays at backs of color blocks to display the corresponding time according to values of the selected color block.

2. The clock timing method based on the Fibonacci sequence of claim 1, wherein backs of said six color block areas are equipped with seven-color LED light arrays, which can make the color blocks display six colors of red, green, blue, yellow, purple and white respectively.

3. The clock timing method based on the Fibonacci sequence of claim 1 or 2, wherein the number of hours of the clock is determined by the sum of the side length values of the red and blue color block areas; the number of minutes is determined by multiplying the sum of the side length values of the green and blue color block areas by 5 plus the side length value of the yellow color block area and subtracting the side length value of the purple color block area.

4. The clock timing method based on the Fibonacci sequence of claim 2, wherein the white color block area is not involved in the calculation of the number of hours and minutes.

5. The clock timing method based on the Fibonacci sequence of claim 1 or 2, wherein the device is provided with a night light mode, capable of providing illumination in dim light conditions.

6. The clock timing method based on the Fibonacci sequence of claim 1, wherein a control unit is provided for adjusting the display color of each color block area according to the value of the time to realize display of time.

7. The clock timing method based on the Fibonacci sequence of claim 1 or 2, wherein a sound feedback function is provided, which emits a specific sound effect to notify the user when the time is changed or a setting is made.

8. A program of the clock timing method based on the Fibonacci sequence, which is used to control the LED light arrays so that the color block areas displays corresponding combination of colors to indicate a specific time point, and the program is capable of corresponding to 780 time points in minutes within a time range of 0:00 to 12:59.

9. A clock timing device based on the Fibonacci sequence, including a physical frame, and six square color block areas are provided in a space area formed in a middle of the physical frame, and the six square color block areas include a first color block area, a second color block area, a third color block area, a fourth color block area, a fifth color block area, and a sixth color block area;
wherein, a first color block area corresponds to side length 1, a second color block area corresponds to side length 1, a third color block area corresponds to side length 2, a fourth color block area corresponds to side length 3, a fifth color block area corresponds to side length 5, and a sixth color block area corresponds to side length 8; each color block area is controlled by a seven-color LED light array to display different colors.

10. The clock timing device based on the Fibonacci sequence of claim 9, wherein back of each color block area is equipped with a seven-color LED light array, which can make the color block display six colors of red, green, blue, yellow, purple and white respectively.
